(19) United States
(12) Patent Application Publication
(10) Pub. No.: US 2026/0072676 A1
(43) Pub. Date: Mar. 12, 2026

(54) VOLTAGE DISCHARGE QUALIFIER FOR EFFECTIVE VIRTUAL ALTERNATING CURRENT SOURCE CYCLING

(71) Applicant: Dell Products L.P., Round Rock, TX (US)

(72) Inventors: Chih-An HUANG, Tucheng (TW); Chia-Chun CHEN, Taipei City (TW); Chun-Chao WANG, Taipei City (TW)

(73) Assignee: Dell Products L.P., Round Rock, TX (US)

(21) Appl. No.: 18/829,637

(22) Filed: Sep. 10, 2024

(51) Int. Cl. G06F 8/656; G06F 1/3228; G06F 1/3246; G06F 21/76

(52) U.S. Cl. CPC G06F 8/656; G06F 1/3228; G06F 1/3246; G06F 21/76

(57) ABSTRACT

An information handling system may include a processor, a logic device communicatively coupled to the processor and configured to perform a function to extend the functionality of the information handling system and a discharge circuit electrically and communicatively coupled to the logic device. The discharge circuit may include a switching network configured to, in response to a trigger for updating functional logic of the logic device, discharge a power rail for providing electrical energy to the logic device and a monitoring circuit configured to monitor a voltage on the power rail and responsive to the voltage falling below a threshold voltage, cause the switching network to cease discharging the power rail and enable completion of an update to the functional logic of the logic device.

### TECHNICAL FIELD

The present disclosure relates in general to information handling systems, and more particularly to methods and systems for sequencing alternating current source (AC) shutdown of a logic device within an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Many information handling systems utilize logic devices, such as complex programmable logic devices (CPLDs) and field-programmable gate arrays (FPGAs) to perform particular defined functionality within such information handling systems. Logic devices may be advantageous to use, as they may be reprogrammable to allow for updates to the functional logic programmed into the logic devices.

On some information handling systems, a problem has been observed in which attempted updates to logic devices are unsuccessful (e.g., attempted updates pause or hang or an older version of the functional logic programming remains). Such problem may be caused by an auxiliary power rail to the logic device not having decreased to a low enough voltage during the update process.

### SUMMARY

In accordance with the teachings of the present disclosure, the disadvantages and problems associated with unsuccessful updates to logic devices may be reduced or eliminated.

In accordance with embodiments of the present disclosure, an information handling system may include a processor, a logic device communicatively coupled to the processor and configured to perform a function to extend the functionality of the information handling system and a discharge circuit electrically and communicatively coupled to the logic device. The discharge circuit may include a switching network configured to, in response to a trigger for updating functional logic of the logic device, discharge a power rail for providing electrical energy to the logic device and a monitoring circuit configured to monitor a voltage on the power rail and responsive to the voltage falling below a threshold voltage, cause the switching network to cease discharging the power rail and enable completion of an update to the functional logic of the logic device.

In accordance with embodiments of the present disclosure, a discharge circuit may be configured to electrically and communicatively couple to a logic device. The discharge circuit may include a switching network configured to, in response to a trigger for updating functional logic of the logic device, discharge a power rail for providing electrical energy to the logic device and a monitoring circuit configured to monitor a voltage on the power rail and responsive to the voltage falling below a threshold voltage, cause the switching network to cease discharging the power rail and enable completion of an update to the functional logic of the logic device.

In accordance with embodiments of the present disclosure, a method may include, in response to a trigger for updating functional logic of a logic device, discharging a power rail for providing electrical energy to the logic device, monitoring a voltage on the power rail, and responsive to the voltage falling below a threshold voltage, causing cessation of discharging the power rail and enabling completion of an update to the functional logic of the logic device.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a block diagram of an example discharge circuit, in accordance with embodiments of the present disclosure; and

FIG. 3 illustrates a flow chart of an example method for discharging an auxiliary power rail of a logic device to ensure effective updating of functional logic of the logic device, in accordance with embodiments of the present disclosure.

### DETAILED DESCRIPTION

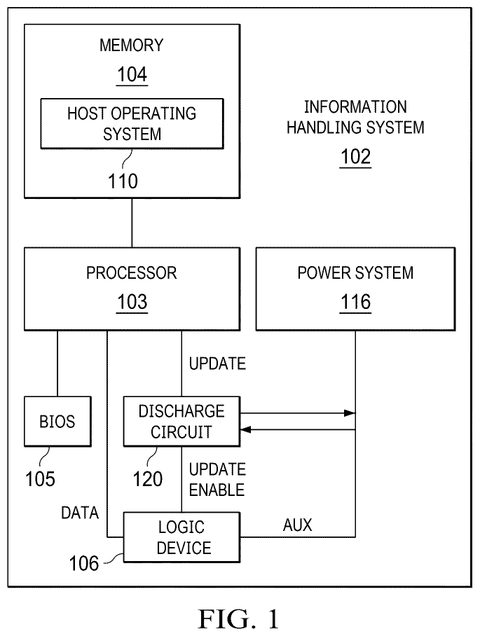

Preferred embodiments and their advantages are best understood by reference to FIGS. 1-3, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise or be an integral part of a server. In other embodiments, information handling system 102 may be a personal computer. In these and other embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a basic input/output (BIOS) system 105 communicatively coupled to processor 103, a logic device 106 communicatively coupled to processor 103, a power system 116 configured to distribute electrical energy to components of information handling system 102, and a discharge circuit 120 electrically and communicatively coupled to logic device 106 and power system 116.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon a host operating system 110. Host operating system 110 may comprise any program of executable instructions, or aggregation of programs of executable instructions, configured to, when executed by processor 103, manage and/or control the allocation and usage of hardware resources of information handling system 102 such as memory, processor time, disk space, and input and output devices, and provide an interface between such hardware resources and application programs hosted by host operating system 110.

BIOS 105 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., memory 104) may be executed by processor 103 and given control of information handling system 102.

Logic device 106 may comprise any suitable system, device, or apparatus that may perform a specialized function that extends the functionality of information handling system 102. In some embodiments, logic device 106 may comprise a complex programmable logic device (CPLD) or a field-programmable gate array (FPGA). As shown in FIG. 1, logic device 106 may be communicatively coupled to processor 103 and/or other components of information handling system 102 in order to communicate data between logic device 106 and processor 103 and/or between logic device 106 and such other components of information handling system 102. As shown in FIG. 1, logic device 106 may also include a control input UPDATE ENABLE that may be asserted to enable an update to the programming of functional logic for logic device 106, and deasserted otherwise. As further depicted in FIG. 1, logic device 106 may be powered from an auxiliary power rail AUX provided by power system 116.

Generally speaking, power system 116 may include any system, device, or apparatus configured to supply electrical current to one or more information handling resources of information handling system 102. Accordingly, power system 116 may include one or more power supply units, one or more voltage regulators, and/or other components. In some embodiments, power system 116 may include one or more programmable components (e.g., a programmable voltage regulator). For purposes of clarity and exposition, power system 116 is depicted in FIG. 1 as being coupled only to logic device 106 and discharge circuit 120, and shown as only generating auxiliary power rail AUX. However, it is understood that power system 116 may be coupled to other components of information handling system 102, and may generate other power rails or sources of electrical energy in order to provide electrical energy to such other components.

Discharge circuit 120 may comprise any system, device, or apparatus configured to, in response to an update trigger UPDATE for updating logic device 106, discharge auxiliary power rail AUX (e.g., which may be withdrawn by power system 116 in connection with update trigger UPDATE being asserted), monitor a voltage present on auxiliary power rail AUX, and responsive to such monitored voltage dropping below a threshold voltage level, enable the update of logic device 106 by asserting control input UPDATE ENABLE. Accordingly, discharge circuit 120 may include a switching network of one or more switches (e.g., transistors) configured to discharge auxiliary power rail AUX (e.g., one or more switches coupled between auxiliary power rail AUX and a ground voltage), logic to perform the monitoring of auxiliary power rail AUX and control of control input UPDATE ENABLE, and/or other electrical and/or electronic components for performing its functionality.

In addition to processor 103, memory 104, BIOS 105, logic device 106, power system 116, and discharge circuit 120, information handling system 102 may include one or more other information handling resources.

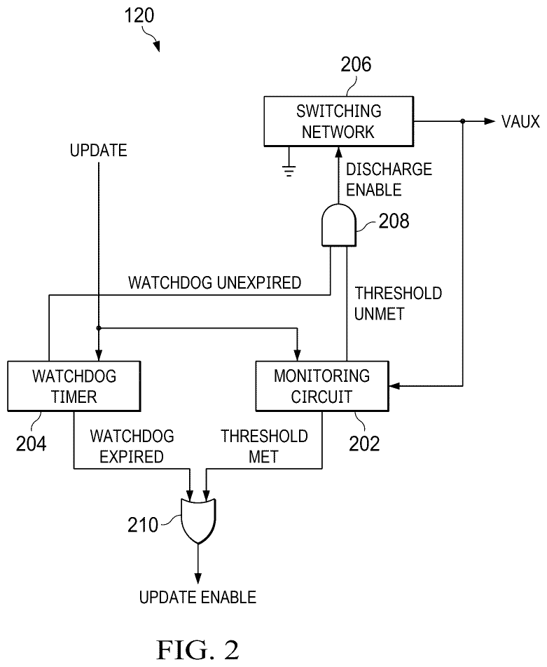

FIG. 2 illustrates a block diagram of an example discharge circuit 120, in accordance with embodiments of the present disclosure. As shown in FIG. 2, discharge circuit 120 may include monitoring circuitry 202, watchdog timer 204, switching network 206, logical AND circuit 208, and logical OR circuit 210.

Monitoring circuit 202 may include any system, device, or apparatus configured to, responsive to assertion of control input UPDATE, begin monitoring (e.g., via a comparator) a voltage present on auxiliary power rail AUX to compare such voltage to a threshold voltage level, and generate one or more threshold comparison output signals (e.g., THRESHOLD MET, THRESHOLD UNMET) indicative of whether the voltage present on auxiliary power rail AUX has decreased below the threshold voltage level.

Watchdog timer 204 may include any system, device, or apparatus configured to, responsive to assertion of control input UPDATE, begin a timer of a predefined duration and generate one or more threshold comparison output signals (e.g., WATCHDOG EXPIRED, WATCHDOG UNEXPIRED) indicative of whether the timer has expired.

Logical AND circuit 208 may comprise any system, device, or apparatus configured to assert a control signal DISCHARGE ENABLE for enabling switching network 206 if the threshold of monitoring circuit 202 is unmet (e.g., the voltage present on auxiliary power rail AUX is greater than the threshold voltage level) and the timer of watchdog timer 204 is unexpired, and may otherwise deassert control signal DISCHARGE ENABLE. Logical AND circuit 208 may be implemented in any suitable digital and/or analog circuitry.

Switching network 206 may comprise any system, device, or apparatus comprising one or more switches (e.g., transistors) and configured to, when control signal DISCHARGE ENABLE is asserted, enable such one or more switches to discharge auxiliary power rail AUX (which may have been separately withdrawn by power system 116 in response to control input UPDATE).

Logical OR circuit 210 may comprise any system, device, or apparatus configured to assert control signal UPDATE ENABLE for enabling logic device 106 to undertake and/or complete an update to its functional logic if the threshold of monitoring circuit 202 is met (e.g., the voltage present on auxiliary power rail AUX is greater than the threshold voltage level) or the timer of watchdog timer 204 is expired, and may otherwise deassert control signal UPDATE ENABLE. Logical OR circuit 210 may be implemented in any suitable digital and/or analog circuitry.

In addition to processor monitoring circuit 202, watchdog timer 204, switching network 206, logical AND gate 208, and logical OR gate 210, discharge circuit 120 may include one or more other components. Furthermore, while watchdog timer 204 (as well as logical AND gate 208 and logical OR gate 210) may be present in some embodiments to prevent an infinite pause or hang in the update process in the event that the threshold of monitoring circuit 202 is never met, in some embodiments, watchdog timer 204 (as well as logical AND gate 208 and logical OR gate 210) may be absent from discharge circuit 120.

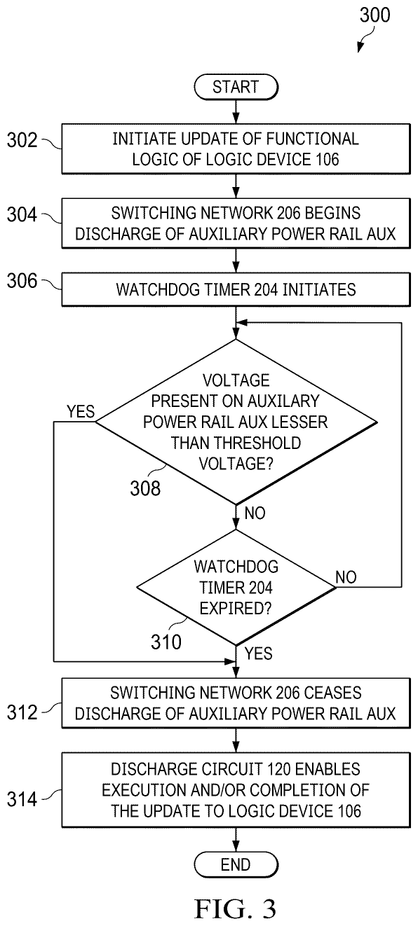

FIG. 3 illustrates a flow chart of an example method 300 for discharging an auxiliary power rail of a logic device to ensure effective updating of functional logic of the logic device, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, processor 103 or another component of information handling system 102 may initiate an update of the functional logic of logic device 106 (e.g., by asserting control input UPDATE).

At step 304, in response to the initiation of the update of the functional logic of logic device 106, switching network 206 may begin discharge of auxiliary power rail AUX. At step 306, in response to the initiation of the update of the functional logic of logic device 106, watchdog timer 204 may initiate its timer.

At step 308, monitoring circuit 202 may compare the voltage present on auxiliary power rail AUX to a threshold voltage. If the voltage present on auxiliary power rail AUX is below the threshold voltage, method 300 may proceed to step 312. Otherwise, method 300 may proceed to step 310.

At step 310, watchdog timer 204 may determine if its timer has expired. If watchdog timer 204 has expired, method 300 may proceed to step 312. Otherwise, method 300 may proceed again to step 308. Notably, in the absence of watchdog timer 204 from discharge circuit 120, step 310 may be absent from method 300, in which case step 308 may repeat until the voltage present on auxiliary power rail AUX is below the threshold voltage.

At step 312, switching network 206 may cease discharge of auxiliary power rail AUX. At step 314, discharge circuit 120 (e.g., via logical OR gate 210) may enable (e.g., via control signal UPDATE ENABLE) execution and/or completion of the update to logic device 106. After completion of step 312, method 300 may end.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102 or any other system operable to implement method 300. In certain embodiments, method 300 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor;
a logic device communicatively coupled to the processor and configured to perform a function to extend the functionality of the information handling system; and
a discharge circuit electrically and communicatively coupled to the logic device, the discharge circuit comprising:
a switching network configured to, in response to a trigger for updating functional logic of the logic device, discharge a power rail for providing electrical energy to the logic device; and
a monitoring circuit configured to:
monitor a voltage on the power rail; and
responsive to the voltage falling below a threshold voltage:
cause the switching network to cease discharging the power rail; and
enable completion of an update to the functional logic of the logic device.

2. The information handling system of claim 1, the discharge circuit further comprising a timer circuit configured to:
initiate a timer in response to the trigger; and
responsive to expiration of the timer, cause the switching network to cease discharging the power rail.

3. The information handling system of claim 1, wherein the logic device comprises a complex programmable logic device.

4. The information handling system of claim 1, wherein the logic device comprises a field-programmable gate array.

5. A discharge circuit configured to electrically and communicatively couple to a logic device, the discharge circuit comprising:
a switching network configured to, in response to a trigger for updating functional logic of the logic device, discharge a power rail for providing electrical energy to the logic device; and
a monitoring circuit configured to:
monitor a voltage on the power rail; and
responsive to the voltage falling below a threshold voltage:
cause the switching network to cease discharging the power rail; and
enable completion of an update to the functional logic of the logic device.

6. The discharge circuit of claim 5, further comprising a timer circuit configured to:
initiate a timer in response to the trigger; and
responsive to expiration of the timer, cause the switching network to cease discharging the power rail.

7. The discharge circuit of claim 5, wherein the logic device comprises a complex programmable logic device.

8. The discharge circuit of claim 5, wherein the logic device comprises a field-programmable gate array.

9. A method comprising, in response to a trigger for updating functional logic of a logic device:
discharging a power rail for providing electrical energy to the logic device;
monitoring a voltage on the power rail; and
responsive to the voltage falling below a threshold voltage:
causing cessation of discharging the power rail; and
enabling completion of an update to the functional logic of the logic device.

10. The method of claim 9, further comprising:
initiating a timer in response to the trigger; and
responsive to expiration of the timer, causing cessation of discharging the power rail.

11. The method of claim 9, wherein the logic device comprises a complex programmable logic device.

12. The method of claim 9, wherein the logic device comprises a field-programmable gate array.
